(19) United States
(12) Patent Application Publication
(10) Pub. No.: US 2008/0002054 A1
(43) Pub. Date: Jan. 3, 2008

(54) Video signal diagonal interpolation apparatus

(75) Inventor: Toshiyuki Namioka, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/808,673

(22) Filed: Jun. 12, 2007

(30) Foreign Application Priority Data
Jun. 30, 2006 (JP) 2006-181967

(51) Int. Cl. H04N 11/20

(52) U.S. Cl. 348/448; 348/E11.021

(57) ABSTRACT

According to one embodiment, a video signal diagonal interpolation apparatus performs a diagonal interpolation in a high correlation diagonal direction having the highest correlation in a video signal and a delay signal in which the video signal is delayed. The video signal diagonal interpolation apparatus has a longitudinal-diagonal correlations detection device respectively detecting an upper side diagonal correlation along the high correlation diagonal direction of an upper side pixel positioning at an upper side of an interpolation pixel, and a lower side diagonal correlation along the high correlation diagonal direction of a lower side pixel positioning at a lower side of the interpolation pixel, as for the interpolation pixel disposed at an interpolation position in the high correlation diagonal direction. Besides, the video signal diagonal interpolation apparatus has an interpolation signal output device outputting an interpolation signal in which a diagonal sum in the high correlation direction and longitudinal sum in the video signal and delay signal are mixed in accordance with a detected result of the longitudinal-diagonal correlations detection device.

### CROSS-REFERENCE TO RELATED APPLICATIONS

This application is based upon and claims the benefit of priority from Japanese Patent Application No. 2006-181967, filed Jun. 30, 2006, the entire contents of which are incorporated herein by reference.

### BACKGROUND

1. Field

One embodiment of the invention relates to a video signal diagonal interpolation apparatus applied to a video signal scaling apparatus performing a compression or expansion process of the number of pixels for a video signal in a horizontal or vertical direction.

2. Description of the Related Art

A variety of formats exist in a video signal which is currently in practical use, for example, an NTSC (National Television System Committee), PAL (Phase Alternation by Line color television), for a high-definition television and personal computer, and so on.

It has been necessary to compress or expand the number of pixels of the video signal in a horizontal or vertical direction so as to match the number of display pixels of a display device, when a video is displayed on the display device such as a liquid crystal display and plasma display by using the video signal in the variety of formats as stated above.

An apparatus performing the compression or expansion process for the video signal is called as a video signal scaling apparatus.

Besides, when the expansion process is performed for the video signal by the video signal scaling apparatus, an aliasing display having a level difference in a diagonal edge is made when the video signal having an end portion in a diagonal direction (called also as the diagonal edge) is displayed only if the pixels are increased by referring to a difference in the horizontal or vertical direction.

Accordingly, in the video signal scaling apparatus, a diagonal interpolation apparatus interpolating appropriate pixels while considering a correlation of the pixels in the diagonal direction is provided so as to resolve the aliasing display in such diagonal edge.

Conventionally, for example, there is a scanning line interpolation apparatus disclosed in Japanese Patent Application Publication (KOKAI) No. 4-364685 (Patent Document 1) as for an apparatus performing the diagonal interpolation. The diagonal interpolation is performed as stated below in this scanning line interpolation apparatus. Namely, in this scanning line interpolation apparatus, a video signal and a delay signal in which the video signal is delayed for one horizontal period are inputted, a difference absolute value between pixels disposed in a longitudinal direction and a difference absolute value between pixels disposed in a diagonal direction are calculated, and the pixel having the strongest correlation is judged by a diagonal direction judging circuit from the respective absolute values. Subsequently, an interpolation pixel is generated by a diagonal summing circuit by using the judged pixel, and the diagonal interpolation is performed by the generated interpolation pixel. Incidentally, the diagonal interpolation is disclosed also in International Publication No. WO 2004-17634 (Patent Document 2), Japanese Patent Application Publication (KOKAI) No. 2002-185934 (Patent Document 3), Japanese Patent Application Publication (KOKAI) No. 2001-94951 (Patent Document 4), and so on, in addition to the Patent Document 1.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a video signal diagonal interpolation apparatus according to the an embodiment of the invention;

FIG. 2 is an exemplary view showing a detecting direction of a diagonal correlation by the video signal diagonal interpolation apparatus in the embodiment;

FIG. 3 is an exemplary view showing an example of a video signal, 1H delay signal, and interpolation signal in the embodiment; and

FIG. 4 is an exemplary view showing another example of the video signal, 1H delay signal, and interpolation signal in the embodiment.

### DETAILED DESCRIPTION

Various embodiments according to the invention will be described hereinafter with reference to the accompanying drawings. In general, according to one embodiment of the invention, a video signal diagonal interpolation apparatus performs a diagonal interpolation in a high correlation diagonal direction having the highest correlation in a video signal and delay signal in which the video signal is delayed. The video signal diagonal interpolation apparatus has a longitudinal-diagonal correlations detection device respectively detecting an upper side diagonal correlation along the high correlation diagonal direction of an upper side pixel positioning at an upper side of an interpolation pixel, and a lower side diagonal correlation along the high correlation diagonal direction of a lower side pixel positioning at a lower side of the interpolation pixel, as for the interpolation pixel disposed at an interpolation position in the high correlation diagonal direction. Besides, the video signal diagonal interpolation apparatus has an interpolation signal output device outputting an interpolation signal in which a diagonal sum in the high correlation direction and longitudinal sum in the video signal and delay signal are mixed in accordance with a detected result of the longitudinal-diagonal correlations detection device.

### Configuration of Video Signal Diagonal Interpolation Apparatus

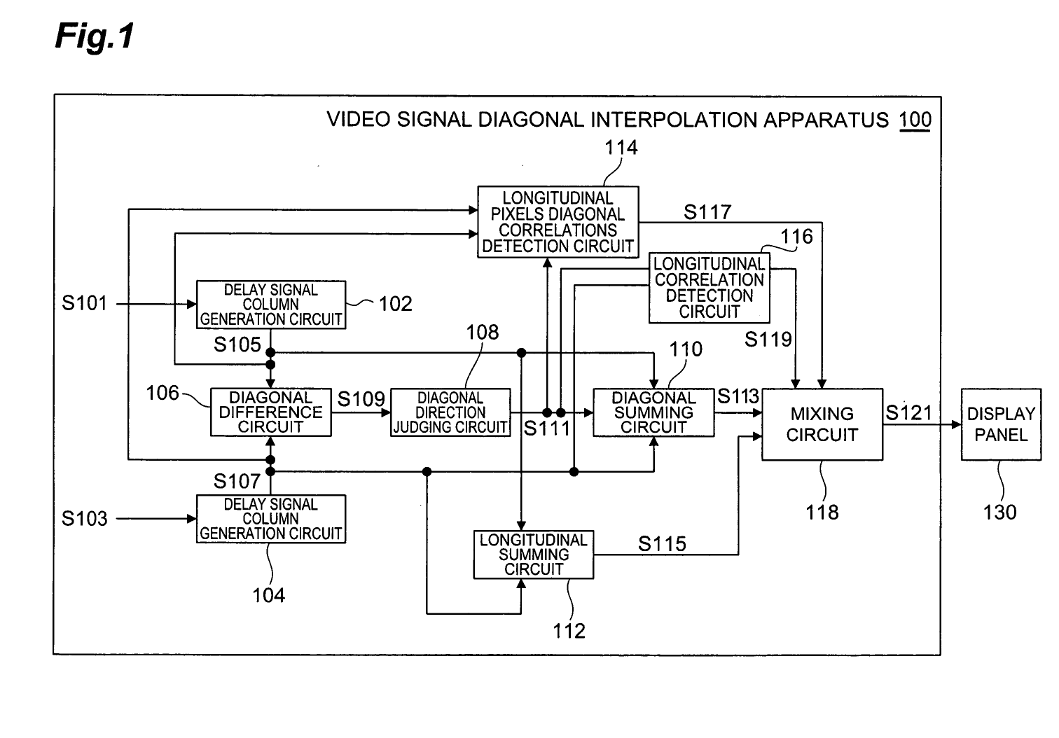

FIG. 1 is a block diagram showing a configuration of a video signal diagonal interpolation apparatus 100 according to an embodiment of the present invention. The video signal diagonal interpolation apparatus 100 is incorporated in a not-shown video signal scaling apparatus, and a video signal S101 inputted to the video signal scaling apparatus and a 1H delay signal S103 delaying the video signal S101 for 1H are inputted thereto. Besides, the video signal diagonal interpolation apparatus 100 generates and outputs an interpolation signal S121 by using the video signal S101 and 1H delay signal S103. The video signal diagonal interpolation apparatus 100 is connected a display panel 130. The video signal diagonal interpolation apparatus 100 outputs the interpolation signal S121 to the display panel 130. The video signal diagonal interpolation apparatus 100 controls the display of video by the display panel 130 using the interpolation signal S121. The display panel 130 displays video using the interpolation signal S121.

The video signal diagonal interpolation apparatus 100 has a first delay signal column generation circuit 102, second delay signal column generation circuit 104, diagonal difference circuit 106, and diagonal direction judging circuit 108. Besides, the video signal diagonal interpolation apparatus 100 has a diagonal summing circuit 110, longitudinal summing circuit 112, longitudinal pixels diagonal correlations detection circuit 114, longitudinal correlation detection circuit 116, and mixing circuit 118.

The video signal S101, 1H delay signal S103 are respectively inputted to the first and second delay signal column generation circuits 102, 104. Besides, the first and second delay signal column generation circuits 102, 104 respectively have plural delay taps, and respectively output a first delay signal column S105, second delay signal column S107 by using the respective delay taps. Both of the first delay signal column S105, second delay signal column S107 are inputted to the diagonal difference circuit 106, diagonal summing circuit 110, longitudinal summing circuit 112, longitudinal pixels diagonal correlations detection circuit 114, and longitudinal correlation detection circuit 116.

The diagonal difference circuit 106 inputs the first delay signal column S105 and second delay signal column S107, and calculates plural difference absolute values in plural diagonal directions to detect the correlations in the diagonal directions (diagonal correlation) of both of the first delay signal column S105 and second delay signal column S107. Subsequently, the diagonal difference circuit 106 outputs a data showing the calculated difference absolute values as a diagonal difference absolute value data S109 to the diagonal direction judging circuit 108.

The diagonal direction judging circuit 108 inputs the diagonal difference absolute value data S109, and detects the diagonal correlations of the first delay signal column S105 and second delay signal column S107 based on the diagonal difference absolute value data S109. Besides, the diagonal direction judging circuit 108 has a function as a diagonal direction detection device detecting the highest correlation direction as a high correlation diagonal direction based on the detected diagonal correlation, and outputs a diagonal direction judging signal S111 showing the detected result. This diagonal direction judging signal S111 is inputted to the diagonal summing circuit 110 and the longitudinal pixels diagonal correlations detection circuit 114.

The diagonal summing circuit 110 calculates a diagonal sum of the respective pixels along the high correlation diagonal direction which is judged to have the highest correlation in accordance with the diagonal direction judging signal S111 from the first delay signal column S105 and second delay signal column S107, and outputs the calculated diagonal sum as a diagonal sum signal S113.

The longitudinal summing circuit 112 calculates the longitudinal sum of the respective pixels by using the first delay signal column S105 and second delay signal column S107, and outputs the calculated longitudinal sum as a longitudinal sum signal S115.

The longitudinal pixels diagonal correlations detection circuit 114 is a longitudinal-diagonal correlations detection device, detects a later-described upper side diagonal correlation and lower side diagonal correlation along the high correlation diagonal direction, based on the detected result of the diagonal direction judging circuit 108 (namely, the diagonal direction judging signal S111), and outputs a longitudinal pixels diagonal correlations signal S117 corresponding to the detected result. Incidentally, the detections of the upper side diagonal correlation and lower side diagonal correlation performed by the longitudinal pixels diagonal correlations detection circuit 114 is called as a “longitudinal-diagonal correlations detection”, and it is described later in detail.

The longitudinal correlation detection circuit 116 calculates a difference in the longitudinal direction of the respective pixels by using the first delay signal column S105 and second delay signal column S107, on the other hand, detects the longitudinal correlation from the calculated difference to output a longitudinal correlation detection signal S119 showing the detected longitudinal correlation.

The mixing circuit 118 is an interpolation signal output device, and inputs the diagonal sum signal S113, longitudinal sum signal S115, longitudinal pixels diagonal correlations signal S117, and longitudinal correlation detection signal S119, to output the interpolation signal S121. This interpolation signal S121 is a signal in which the diagonal sum signal S113 and longitudinal sum signal S115 are mixed in accordance with the longitudinal pixels diagonal correlations signal S117 and longitudinal correlation detection signal S119.

### Operation contents of Video Signal Diagonal Interpolation Apparatus

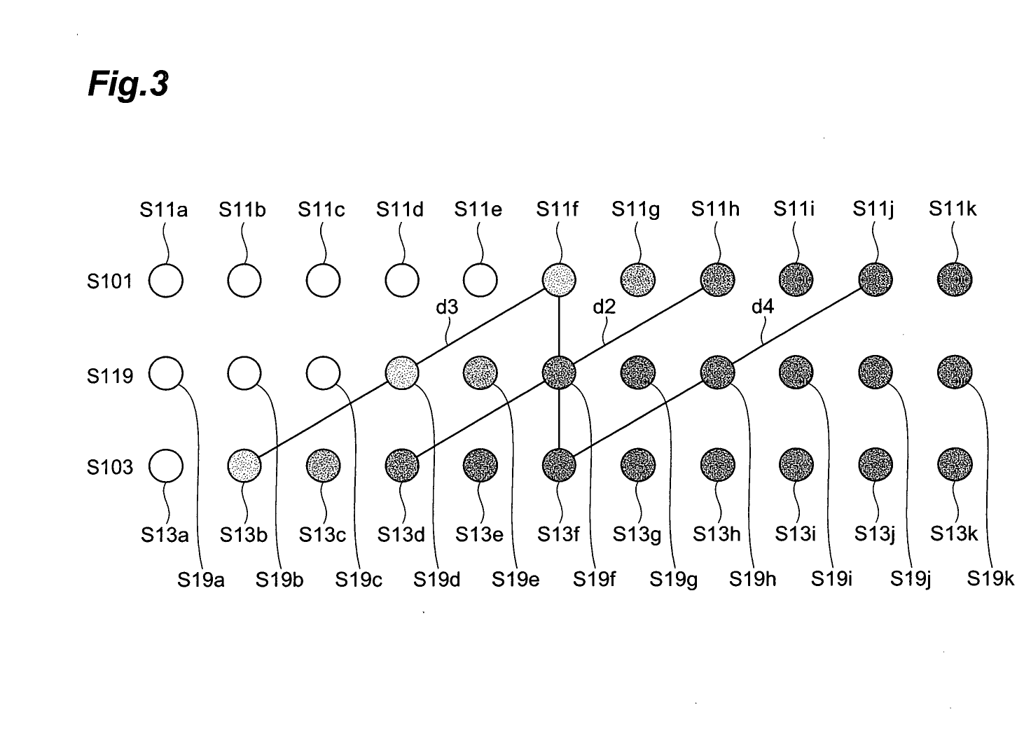

Next, operation contents of the video signal diagonal interpolation apparatus 100 are described. Here, a case when the video signal S101 and 1H delay signal S103 having the diagonal edge as shown in FIG. 3 are inputted to the video signal diagonal interpolation apparatus 100, is described as an example. At this time, the video signal diagonal interpolation apparatus 100 generates the interpolation signal S121 by operating as stated below.

Here, the video signal S101 and 1H delay signal S103 are constituted by the pixels as shown in FIG. 3. The video signal S101 has eleven pixels from S11a to S11k. Among them, five pixels of S11a, S11b, S11c, S11d, S11e are, for example, white with the same brightness, S11f is pale gray, S11g is gray, S11h is deep gray, and three pixels of S11i, S11j, S11k are black with the same brightness.

Besides, in the 1H delay signal S103, brightness of the pixels changes from S13a to S13k, and S13a is white, S13b is pale gray, S13c is gray, S13d is deep gray, and seven pixels of 813e, S13f, S13g, S13h, S13i, S13j, and S13k are black with the same brightness.

When a video is displayed by using the video signal S101 and 1H delay signal S103 as stated above, the video having the diagonal edge in which the pixel S11f and pixel S13b become boundary, is displayed.

When the video signal S101 and 1H delay signal S103 are respectively inputted to the first and second delay signal column generation circuits 102, 104, the first delay signal column S105 and second delay signal column S107 are generated, to be inputted to the diagonal difference circuit 106.

The diagonal difference circuit 106 calculates the difference absolute values as for the pixels disposed in the plural diagonal directions from the inputted first delay signal column S105 and second delay signal column S107, and outputs the diagonal difference absolute value data S109.

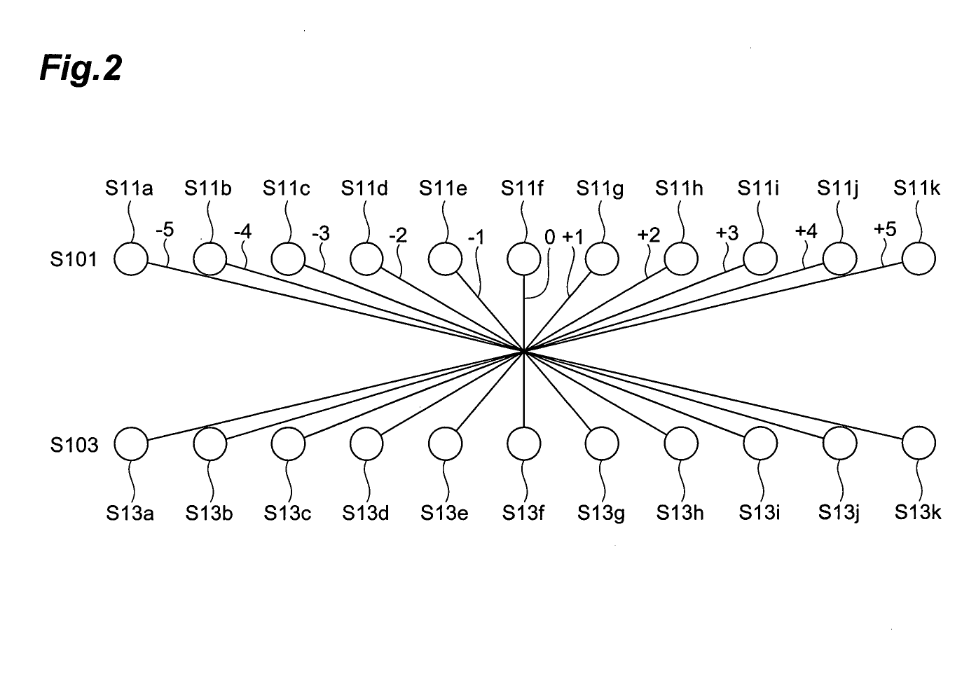

Here, the diagonal difference circuit 106 calculates the difference absolute values between the pixels with each other disposed such that a positional relationship is in the diagonal direction with each other (or in the longitudinal direction) such as S11a and S13k, S11b and S13j, S11c and S13i, and so on, as for the plural pixels S11a to S11k constituting the video signal S101 and the plural pixels S13a to S13k constituting the 1H delay signal S103, as shown in FIG. 2.

Consequently, the diagonal difference circuit 106 calculates the difference absolute values of the pixels with each other disposed in eleven ways of directions from “−5” to “+5”, as shown in FIG. 2.

The diagonal direction judging circuit 108 inputs the diagonal difference absolute value data S109, detects the direction having the highest correlation from among the eleven ways of diagonal directions shown in FIG. 2 as the high correlation diagonal direction, based on the difference absolute values calculated by the diagonal difference circuit 106, and outputs the diagonal direction judging signal S111.

Here, the video signal S101 and 1H delay signal S103 are constituted by the pixels as shown in FIG. 3, and therefore, the correlation between the pixel S11h and pixel S13d is high. Accordingly, the diagonal direction judging circuit 108 judges a diagonal direction d2 as the high correlation diagonal direction, and outputs the diagonal direction judging signal S111.

The diagonal summing circuit 110 calculates the diagonal sum in accordance with the diagonal direction judging signal S111, and therefore, the diagonal sum signal S113 is outputted by calculating the diagonal sum of the respective pixels in the diagonal direction d2, namely,the diagonal sum of the respective pixels along the diagonal direction d2 including the diagonal sum of the pixel S11h and pixel S13d.

Besides, the longitudinal summing circuit 112 calculates the longitudinal sum of the respective pixels by using the first delay signal column S105 and second delay signal column S107, and therefore, it calculates the longitudinal sums of the video signal S101 and 1H delay signal S103 such as the pixels S11a and S13a, S11b and S13b, S11c and S13c, and so on, to output the longitudinal sum signal S115.

The longitudinal pixels diagonal correlations detection circuit 114 performs the longitudinal-diagonal correlations detection as stated below. In this case, the direction judged as the high correlation diagonal direction at the diagonal direction judging circuit 108 is the diagonal direction d2, and therefore, a pixel S19f becomes an interpolation pixel if a pixel disposed at an interpolation position between the pixels S11h and S13d is the interpolation pixel.

The longitudinal pixels diagonal correlations detection circuit 114 detects the correlations in the same diagonal direction as the diagonal direction d2 respectively seen from the pixel S11f positioning at an upper side of the interpolation pixel S19f and the pixel S13f positioning at a lower side thereof (a pixel positioning at the upper side of the interpolation pixel is called as an “upper side pixel”, and a pixel positioning at the lower side is called as a “lower side pixel”).

In this case, the interpolation pixel in the diagonal direction d2 is the pixel S19f, and therefore, the upper side pixel is S11f, and the lower side pixel is S13f. Consequently, a diagonal direction which is the same as the diagonal direction d2 seen from the upper side pixel S11f is a diagonal direction d3, and a diagonal direction which is the same as the diagonal direction d2 seen from the lower side pixel S13f is a diagonal direction d4.

Incidentally, in the following description, the diagonal direction which is the same as the high correlation diagonal direction (the diagonal direction d2 in the above description) seen from the upper side pixel is set as an upper side diagonal direction, and the diagonal direction which is the same as the diagonal direction d2 seen from the lower side pixel is set as a lower side diagonal direction. Besides, a correlation in the upper side diagonal direction is called as an upper side diagonal correlation, and a correlation in the lower side diagonal direction is called as a lower side diagonal correlation.

Accordingly, the upper side diagonal correlation is the correlation between the upper side pixel S11f and the lower side pixel S13b disposed in the diagonal direction d3, and the lower side diagonal correlation is the correlation between the upper side pixel S11j and the lower side pixel S13f disposed in the diagonal direction d4 as shown in FIG. 3, and both correlations are judged to be high.

The longitudinal pixels diagonal correlations detection circuit 114 detects the upper side diagonal correlation and the lower side diagonal correlation as for such diagonal directions d3, d4, and outputs the longitudinal pixels diagonal correlations signal S117 in accordance with the detected result. However, the upper side diagonal correlation and lower side diagonal correlation vary depending on the pixels of the video signal S101 and the pixels of the 1H delay signal S103, and therefore, the longitudinal pixels diagonal correlations signal S117 becomes a data showing the upper side diagonal correlation and lower side diagonal correlation (hereinafter, both are collectively referred to as “longitudinal-diagonal correlations”.

The mixing circuit 118 changes a mixture rate of the diagonal sum signal S113 and longitudinal sum signal S115 in accordance with the longitudinal pixels diagonal correlations signal S117 and longitudinal correlation detection signal S119, to generate the interpolation signal S121. In this case, the mixing circuit 118 performs an operation as a comparison device comparing the longitudinal-diagonal correlations shown by the longitudinal pixels diagonal correlations signal S117 and the longitudinal correlation shown by the longitudinal correlation detection signal S119, and changes the mixture rate of the diagonal sum signal S113 and longitudinal sum signal S115 in accordance with the comparison result.

Namely, in the mixing circuit 118, it is constituted such that the diagonal sum is outputted easily as the longitudinal-diagonal correlations become higher than the longitudinal correlation. Concretely speaking, the mixing circuit 118 is constituted such that the diagonal sum signal S113 is outputted in preference to the longitudinal sum signal S115 when the longitudinal-diagonal correlations are higher than the longitudinal correlation.

Besides, the mixing circuit 118 is constituted such that the longitudinal sum signal S115 is outputted gradually in addition to the diagonal sum signal S113 as the longitudinal-diagonal correlations become lower, and the longitudinal sum signal S115 is outputted in preference to the diagonal sum signal S113 when the longitudinal-diagonal correlations become not more than the longitudinal correlation.

In the above-stated embodiment, the correlations are high as for the diagonal directions d3, d4 in addition to the diagonal direction d2, when the longitudinal-diagonal correlations and the longitudinal correlation are compared. On the contrary, the correlation between the upper side pixel S11f and the lower side pixel S13f does not exist, and therefore, the longitudinal correlation is low. Consequently, the diagonal sum signal S113 is given priority over the longitudinal sum signal S115, and the diagonal sum signal S113 is outputted as the interpolation signal S121 (the pixel S19f is generated by the diagonal sum of the pixel S11h and pixel S13d).

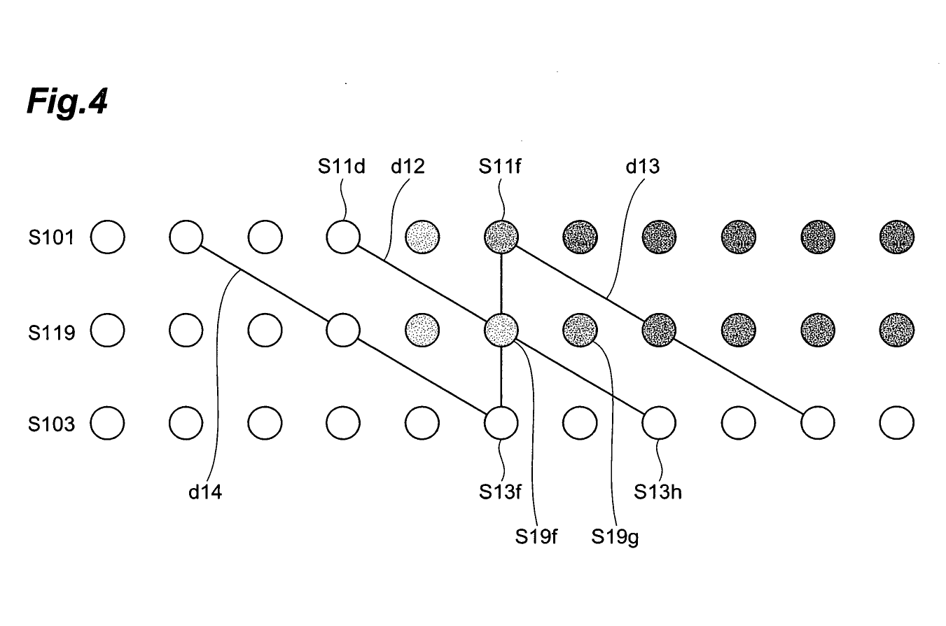

FIG. 4 is a view showing the video signal S101 and 1H delay signal S103 when it is assumed that a line boundary comes to a cut line such as a corner of a square object and so on. In this case, the high correlation direction judged by the diagonal direction judging circuit 108 shows a diagonal direction d12.

However, as shown in FIG. 4, the 1H delay signal S103 is the pixels in which an object is not displayed, and therefore, there is no correlation between the video signal S101 and 1H delay signal S103 in any diagonal direction. However, if the diagonal sum is outputted as the interpolation signal S121 because the high correlation diagonal direction is the diagonal direction d12, an inadequate interpolation pixel is generated in a vicinity of the cut line, and thereby, a video becomes to be the one in which a corner is chipped.

Besides, on the other hand, when the diagonal edge is gradual, there is a case when the diagonal edge is not detected. However, in the conventional scanning line interpolation apparatus disclosed in the Patent Document 1, there was a case when the diagonal sum and the longitudinal sum are switched in rapid succession depending on whether the edge is detected or not.

However, in the video signal diagonal interpolation apparatus 100 according to the present embodiment, the video signal S101 and 1H delay signal S103 as shown in FIG. 4 also become as stated below.

In FIG. 4, the high correlation diagonal direction is the diagonal direction d12, and therefore, the interpolation pixel is S19f, the upper side pixel is S11f, and the lower side pixel is S13f. Consequently, a diagonal direction which is the same as the diagonal direction d12 seen from the upper side pixel S11f is a diagonal direction d13, and a diagonal direction which is the same as the diagonal direction d12 seen from the lower side pixel S13f is a diagonal direction d14.

Besides, it can be said that there is the lower side diagonal correlation, because the correlation of the diagonal direction d14 is high. However it cannot be said that there is the upper side diagonal correlation because the correlation of the diagonal direction d13 is low. On the other hand, the correlation between the upper side pixel S11f and the lower side pixel S13f is low, and therefore, the longitudinal correlation between this upper side pixel S11f and lower side pixel S13f is equal to the upper side diagonal correlation, and it is conceivable that there is no difference.

Namely, both of the upper side diagonal correlation and longitudinal correlation are low, and merits are not recognized between them. Accordingly, the mixing circuit 118 gives priority to the longitudinal sum because the diagonal correlation does not exist, and outputs the longitudinal sum signal S115 as the interpolation signal S121.

As stated above, in the video signal diagonal interpolation apparatus 100, the interpolation signal S121 in which the diagonal sum signal S113 and longitudinal sum signal S115 are mixed is generated by the mixing circuit 118, and the interpolation signal S121 is outputted. Accordingly, in the video signal diagonal interpolation apparatus 100, the diagonal sum signal S113 and longitudinal sum signal S115 are not switched to be outputted in rapid succession, and a quality level of a displayed video does not deteriorate.

Besides, in the mixing circuit 118, the interpolation signal S121 is generated while changing the mixture rate of the diagonal sum signal S113 and longitudinal sum signal S115, in accordance with the longitudinal pixels diagonal correlations signal S117 and the longitudinal correlation detection signal S119. Accordingly, the interpolation signal S121 becomes the signal in line with the stronger correlation among the diagonal correlation and the longitudinal correlation, and the quality level of the video is enhanced also in this point.

Further, the mixing circuit 118 is constituted such that the diagonal sum is outputted easily as the longitudinal-diagonal correlations become higher than the longitudinal correlation. Consequently, when the diagonal correlation is high, the interpolation pixel is generated by the diagonal sum, and therefore, the quality level of the video is enhanced also in this point.

It should be noted that the above-stated description is to describe the embodiment of the present invention, and not to limit the device and method of the present invention. Accordingly, various modified examples can be embodied easily. Also, the device and method constituted by appropriately combining the components, functions, characteristics, and method steps disclosed in the above-described embodiments are also included in the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal diagonal interpolation apparatus, performing a diagonal interpolation in a high correlation diagonal direction having the highest correlation in a video signal and a delay signal delaying the video signal, said video signal diagonal interpolation apparatus comprising:
a longitudinal-diagonal correlations detection device respectively detecting an upper side diagonal correlation along the high correlation diagonal direction of an upper side pixel positioning at an upper side of an interpolation pixel, and a lower side diagonal correlation along the high correlation diagonal direction of a lower side pixel positioning at a lower side of the interpolation pixel, as for the interpolation pixel disposed at an interpolation position in the high correlation diagonal direction; and
an interpolation signal output device outputting an interpolation signal in which a diagonal sum in the high correlation diagonal direction and a longitudinal sum in the video signal and delay signal are mixed in accordance with a detected result of said longitudinal-diagonal correlations detection device.

2. The video signal diagonal interpolation apparatus according to claim 1, further comprising:
a longitudinal correlation detection device detecting a longitudinal correlation between the video signal and delay signal, and
wherein said interpolation signal output device changes a mixture rate of the diagonal sum and the longitudinal sum in accordance with a comparison result of the upper side diagonal correlation and lower side diagonal correlation detected by said longitudinal-diagonal correlations detection device, and the longitudinal correlation detected by said longitudinal correlation detection device.

3. The video signal diagonal interpolation apparatus according to claim 1,
wherein said interpolation signal output device outputs the interpolation signal such that the diagonal sum is given priority over the longitudinal sum as the upper side diagonal correlation and lower side diagonal correlation become higher than the longitudinal correlation.

4. The video signal diagonal interpolation apparatus according to claim 1, further comprising:
a diagonal direction detection device detecting the high correlation diagonal direction, and
said longitudinal-diagonal correlations detection device respectively detects the upper side diagonal correlation and lower side diagonal correlation based on a detected result of said diagonal direction detection device.

5. The video signal diagonal interpolation apparatus according to claim 1, further comprising:
a delay signal column generation device generating delay signal columns based on the video signal and delay signal, and
wherein said longitudinal-diagonal correlations detection device respectively detects the upper side diagonal correlation and lower side diagonal correlation based on the delay signal columns generated by said delay signal column generation device.

6. The video signal diagonal interpolation apparatus according to claim 1, further comprising:
display control unit controlling the display of video using the interpolation signal.
